(19) United States
(12) Patent Application Publication
(10) Pub. No.: US 2013/0039096 A1
(43) Pub. Date: Feb. 14, 2013

(54) RENEWABLE ENERGY OUTPUT MONITORING

(71) Applicants: Scott Alan Meredith-Jones, Newtown (GB); Stephen Turner, Shrewsbury (GB)

(72) Inventors: Scott Alan Meredith-Jones, Newtown (GB); Stephen Turner, Shrewsbury (GB)

(21) Appl. No.: 13/558,633

(22) Filed: Jul. 26, 2012

(30) Foreign Application Priority Data
Aug. 9, 2011 (GB) 1113725.4

(51) Int. Cl. H02M 7/44

(52) U.S. Cl. 363/13

(57) ABSTRACT

An electrical power generating system based on a photovoltaic cell array comprises means for monitoring the output of the array in order to determine whether the output is sufficient to sustain supply to a connected power network. The output of the array is monitored by sensing the voltage across a resistor connected across the array output. The array is connected to the network when a predetermined threshold is reached.

### CROSS-REFERENCE TO RELATED APPLICATION

This application claims the benefit and priority of British Patent Application No. GB 1113725.4 filed Aug. 9, 2011. The entire disclosure of the above application is incorporated herein by reference.

### FIELD

This invention relates to an output power monitoring system for a source of electrical power derived from renewable energy, particularly but not exclusively, solar energy.

### BACKGROUND

Solar energy is converted into electrical energy using a photovoltaic (PV) cell. Banks of such cells are often deployed together as a PV array. The electrical output of a PV array is typically fed into an a.c. supply grid. The d.c. voltage of the array is converted into the a.c. voltage of the supply grid by a bulk inverter or grid-tie inverter. The bulk or grid-tie inverter is used to make the electrical power supplied to the grid of the correct frequency and voltage. A known range of grid-tie inverters is manufactured by Control Techniques of Newtown, Powys, Wales. Electrical energy is also sometimes supplied to a d.c. storage network instead of an a.c. grid.

The same or at least similar considerations apply in other renewable energy situations, such as wind energy systems in which such inverters are often used as well.

The management of energy derived from renewable sources, such as solar energy, has to take account of the fact that the energy source is intermittent. For example, the sun's power is only potentially available for a proportion of the day, but it is also subject to variation in daylight hours due to the weather. Another factor affecting the output of a PV cell is the ambient temperature. These are different aspects but can also combine such that, at the start of the day, the actual moment at which there is sufficient solar power to contribute to the production of electrical power in a grid is not predictable. Thus, merely timing the switching of an array of photovoltaic cells may not coincide with sufficient solar power being available if the day is cloudy and/or very cold.

If a PV array is switched into a grid system too early, i.e. before there is sufficient irradiation (exposure to the sun) and/or it is too cold, there will not be sufficient output from it to overcome the losses in the supplied grid or network. In this case the inverter output will consume power instead of producing it. Failure to properly switch in the array will necessitate resetting before an attempt can again be made to switch it into the grid. Of course, a second or further attempt to switch the PV array into the grid might well fail unless the irradiation level has improved. Thus, the effect of a failed switching attempt includes the consumption of power, wear on the contactors used in the inverter switches and delay, leading to potential loss of useful power generation before a further attempt can be made that is successful.

### SUMMARY

According to embodiments there is provided an electrical power generating system comprising means for producing electrical power from a source of renewable energy, transducer means for providing a signal indicative of the power available from the means for producing, first switch means for connecting the transducer means across the means for producing and control means operable to monitor the signal and to open the switch means when the power exceeds a predetermined magnitude.

Also disclosed is a method of controlling an electrical output of means for producing electrical power from a source of renewable energy, comprising: monitoring the power output of the means for producing; disabling the monitoring when the power exceeds a predetermined magnitude; and connecting the output of the means for producing to an output stage for supply to a power network.

Embodiments disclosed herein provide an energy generating system comprising a converter of renewable energy into an electrical output, means for creating a voltage drop between first and second points in the output, means for monitoring the voltage drop, and switch means for enabling the electrical output of the energy generating system by closing in response to an output of the monitoring means indicating a voltage from the converter being above a predetermined threshold.

Sources of renewable energy are not always able to provide a suitable level of output power. The disclosed embodiments are able to determine the earliest reliable point at which means for deriving electrical power from a source of renewable energy is able to contribute power to a network. By monitoring (preferably constantly) a signal indicative of the power produced by the source of the electrical energy it can be switched in only when it has the output to sustain the delivery of power by overcoming the losses in the system by which it is connected. The system enables the electrical power to be switched into a grid or network at the earliest appropriate time. The system avoids the typical cycle of resetting a system which will otherwise cause delay before a further attempt at switching can be made. The system also avoids the source of the electrical energy consuming power before it is able to deliver power. Thus, disclosed embodiments enhance the reliability of harvesting power from a renewable source of variable but unpredictable output.

Preferably, the means for providing a signal comprise means for creating a voltage drop across the output of the converter and means for providing a signal indicative of the voltage drop to the control means. Preferably, the means for monitoring comprise a transducer operable to provide a signal indicative of a voltage across a resistor connected across the output of the converter.

Preferably, the means for producing comprise a photovoltaic cell or an array of such cells.

Preferably, the output stage comprises means operable to convert an output d.c. voltage from the converter into an a.c. voltage. This may be an inverter, for example, a grid-tie inverter.

Preferably, the control unit switches in the means for producing electrical power when the available output power exceeds the minimum power required to contribute to the network plus the losses associated with the output stage.

The disclosed embodiments represent a highly reliable means of determining the earliest reliable opportunity for switching into a grid or network a source of electrical power derived from renewable energy that is easily implemented even as a retro-fit to existing installations, is rugged and has a long expectancy due to its simplicity.

### DRAWINGS

Embodiments will now be described by way of example with reference to the accompanying drawings in which:

FIG. 1 is a circuit diagram of a PV array and monitoring circuit; and

FIG. 2 is the circuit of FIG. 1 in an electrical grid power management system.

### DETAILED DESCRIPTION

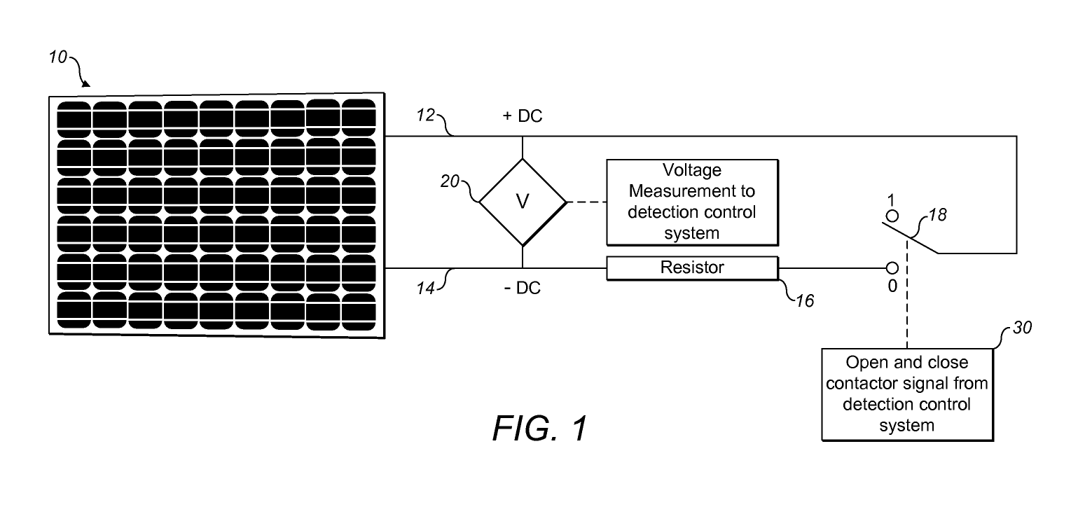

Referring to FIG. 1, a PV array 10 of PV cells has first and second electrically conductive outputs 12 and 14. Under irradiation the PV array 10 produces a DC voltage across the outputs 12 and 14. An electrical resistance 16 and a switch 18 are connected in series across the outputs 12/14. The switch may be a solid state switch, a set of mechanical contactors or any other suitably rated switch means. A voltage sensing device 20 is connected across the outputs 12/14 in parallel with the resistor 16 and switch 18. The electrical resistance 16 may be a power resistor or other device capable of providing a voltage drop which is sensed by the d.c. voltage sensing device 20 to measure the voltage across the PV array. The resistor 16 has a resistance that is equivalent to the losses of a power module to which the electrical output of the PV array is connected for transmission of the generated power to a grid. The power losses are typically 800 W in a power module including a grid-tie inverter as will be described below. The resistance is chosen for the minimum DC voltage at which the PV array is required to deliver power to the grid once losses have been accounted for. The voltage drop is thus proportional to the power available from the array.

Given the typical case of the PV array being switched into the grid in the morning, the event should take place at the earliest possible opportunity, i.e. when there is sufficient potentially sustained irradiation. This is at the threshold when the array output voltage is equal to the sum of the grid-tie inverter system power losses and the minimum required DC voltage. Thus, the resistance 16 has to have a value of:

R=VDCMIN2÷LOSSES
where VDCMIN=√2VSUP+VTOL,
where VSUP=the grid a.c. operating voltage,
and VTOL=a d.c. tolerance level voltage above the minimum d.c. working voltage for the array.

The power rating of the resistor depends on VDC and should be chosen to be capable of handling the maximum voltage available from the array:

Resistor power rating=VDCMAX2÷R

The higher the power rating of the resistor, the more expensive it will be.

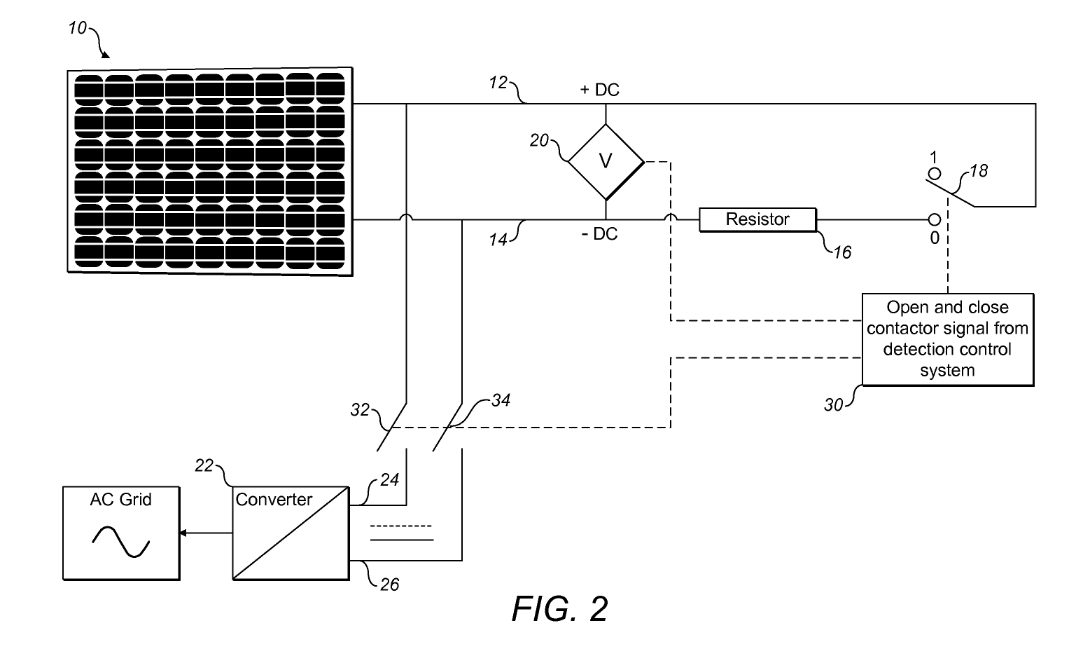

FIG. 2 illustrates the system of FIG. 1 connected as part of a control system for managing power to a grid. Electrical output from the array 10 is supplied to an output stage comprising a d.c./a.c. grid-tie inverter 22 on electrically conductive power lines 24 and 26. The inverter 22 produces an a.c. output that is compatible in phase and frequency with a grid power network voltage which the array is supplying. The skilled reader will appreciate that the supply may take many forms. For example, it may be single phase or multiple (e.g. 3) phase. While a grid-tie inverter is described other means of connecting the output of a source of electrical power to a grid are known depending on the circumstances and the nature of the electrical power supplied and in the network. The use of bulk inverters is referred to above and is equally applicable here. In general, any suitable converter of the supplied power to a form suitable for the supplied network or receiving installation is applicable. Collectively such devices can be referred to as an output stage of the system.

The processing part of the voltage sensing device 20 is shown incorporated into a control unit 30. The processor-based power management control unit 30 receives the output of the voltage sensing device 20. The unit 30 also operates the switch 18 and power breakers 32 and 34 in the power lines 24 and 26. In a typical installation the duties performed by the control unit 30 are programmed in to an overall control unit for the array or multiple arrays.

The operation of the system is as follows: the control unit 30 monitors the PV array output voltage indicated by the sensing device 20. The period of monitoring is governed by the closing of the switch 18 and can be timed to coincide with a period when it is anticipated that there is a likelihood of sufficient irradiation of the array, i.e., at daybreak, or to continuously monitor the voltage across the array while the array is not switched in to the grid. In a period of insufficient irradiation the sensed voltage will not be at the threshold of VDCMIN plus losses associated with the output stage. The control unit 30 will continue to monitor the sensed voltage until the threshold voltage, whereby VDCMIN is available to the grid, is reached. While an instantaneous achievement of VDCMIN for the grid can be used, it is preferable to continue to monitor this sensed voltage until a sustained level of output has been achieved. At that point the minimum power output of the array is available that will avoid a collapse of the system. When the required level of sensed voltage has been reached the switch 18 is opened to disable the monitoring circuit and the power delivery system is enabled by closing the breakers 32 and 34.

This embodiment enables the PV array to be switched into supplying power to the grid at a point where there is sufficient output for the grid to be supplied and to prevent the supply from collapsing due to losses in the output stage. The decision to switch a PV array into a grid is preferably not based on an instantaneous achievement of a threshold as this may be temporary. The unit 10 may monitor the achievement of the threshold for a predetermined time before switching.

As the amount of solar power reduces towards the end of the day the output of the array will eventually reach a level where it is unable to sustain a contribution to the grid. At this point the net flow of power will begin to reverse so that the array starts to consume power from the grid. This is detected by the unit 30. After a short period of power consumption by the array—10 seconds is the preferred period—the switches 32 and 34 are opened to remove the array from the grid. After a longer period the sun will have set further so that the array is no longer producing a significant output, the unit 30 again closes the switch 18 to reconnect the power monitoring system across the array. The unit then continues to monitor the array output until at some point after dawn the output of the array is again sufficient to deliver power to the grid and the process of switching the array into the grid is repeated as before.

In another embodiment the power rating of the resistor 16 can be reduced by modulating the periods for which current is caused to flow through the resistor to an on/off pattern of a duty cycle by operating the switch 18 in its monitoring mode. For example, if the monitoring period is modulated to a five second ON period by closing the switch 18, and a 20 second OFF period, the power rating of the resistor can be reduced by a ratio of 1/5.

Embodiments have been disclosed in relation to a PV array but other sources of renewable energy can benefit from the same monitoring of the energy output when supplying a secondary system such as an electrical power grid. For example, a wind turbine electrical generator could be arranged to be monitored for appropriate conditions according to sustained availability of sufficient wind power. Likewise, wave powered generators can equally well be managed according to the disclosed techniques.

1. An electrical power generating system comprising means for producing electrical power from a source of renewable energy, transducer means for providing a signal indicative of the power available from the means for producing, first switch means for connecting the transducer means across the means for producing and control means operable to monitor the signal and to open the switch means when the power exceeds a predetermined magnitude.

2. A system as claimed in claim 1, in which the transducer means comprise means for creating a voltage drop across the output of the means for producing and means for providing a signal indicative of the voltage drop to the control means.

3. A system as claimed in claim 2 in which the transducer means comprise a transducer operable to provide a signal indicative of a voltage across a resistor connected across the output of the means for producing by the first switch means, wherein the resistor has a resistance that is a function of a required minimum voltage from the output stage and the power losses associated with the output stage.

4. A system as claimed in claim 1 in which the means for producing comprise a photovoltaic cell.

5. A system as claimed in claim 1 wherein the output stage comprises means operable to convert an output d.c. voltage from the means for producing into an a.c. voltage.

6. A system as claimed in claim 5 in which the means comprise a grid-tie inverter or bulk inverter.

7. A system as claimed in claim 1 further comprising second switch means for connecting the means for producing to the output stage, the control means being operable to close the second switch means when the electrical power exceeds the predetermined magnitude.

8. A method of controlling an electrical output of means for producing electrical power from a source of renewable energy, comprising:
monitoring the power output of the means for producing;
disabling the monitoring when the power exceeds a predetermined magnitude; and
connecting the output of the means for producing to an output stage for supply to a power network.

9. A method as claimed in claim 8 in which the monitoring includes sensing a voltage across the output of the means for producing.

10. A method as claimed in claim 9 in which the voltage is sensed across a resistor having a resistance that is a function of the required minimum voltage from the output stage for the network and the losses associated with the output stage.

11. A method as claimed in claim 8 in which the means for producing includes a photovoltaic cell.

12. A method as claimed in claim 8 in which the output stage comprises an inverter, for example a grid-tie inverter or bulk inverter.

13. A method as claimed in claim 8 including connecting the means for producing across the output stage when the electrical power available from the means for producing exceeds the predetermined magnitude.

14. A method as claimed in claim 9 in which the means for producing includes a photovoltaic cell.

15. A method as claimed in claim 10 in which the means for producing includes a photovoltaic cell.

16. A method as claimed in claim 9 in which the output stage comprises an inverter, for example a grid-tie inverter or bulk inverter.

17. A method as claimed in claim 10 in which the output stage comprises an inverter, for example a grid-tie inverter or bulk inverter.

18. A system as claimed in claim 2 in which the means for producing comprise a photovoltaic cell.

19. A system as claimed in claim 3 in which the means for producing comprise a photovoltaic cell.

20. A system as claimed in claim 2 wherein the output stage comprises means operable to convert an output d.c. voltage from the means for producing into an a.c. voltage.
